(19) United States
(12) Patent Application Publication
(10) Pub. No.: US 2017/0307050 A1
(43) Pub. Date: Oct. 26, 2017

(54) MULTIFUNCTIONAL ROTATING ELEMENT FOR POWERTRAIN

(71) Applicant: Nemesys Engineering, LLC, Burnsville, MN (US)

(72) Inventor: Andrew Michael Nelson, Shakopee, MN (US)

(21) Appl. No.: 15/352,905

(22) Filed: Nov. 16, 2016

Related U.S. Application Data
(60) Provisional application No. 62/325,211, filed on Apr. 20, 2016.

(51) Int. Cl. F16H 3/42; F16H 55/17; F16F 15/30

(52) U.S. Cl. CPC F16H 3/426; F16F 15/30; F16H 55/17

(57) ABSTRACT

A multifunctional rotating element is usable as various parts of a powertrain. The multifunctional rotating element includes a body and a plurality of contact elements. The body has an axis of rotation and is configured to rotate about the axis of rotation, and defines a rim portion. The plurality of contact elements are arranged around the rim portion. Each of the contact elements is independently movable between a raised position and a depressed position and biased to the raised position. Each of the contact elements is configured to move to the depressed position when engaged with an object.

### CROSS-REFERENCE TO RELATED APPLICATION

This application claims the benefit of U.S. Patent Application Ser. No. 62/325,211 titled MULTIFUNCTIONAL ROTATING ELEMENT FOR POWERTRAIN, filed Apr. 20, 2016, the disclosure of which is hereby incorporated by reference in its entirety.

### BACKGROUND

### Technical Field

The present disclosure is directed to a multifunctional rotating element for a powertrain, such as a transmission system and the wheels of a vehicle.

### Prior Art

A powertrain in a motor vehicle is a set of components that generate power and deliver it to an output to propel the vehicle. The powertrain may include the engine, transmission, drive shafts, differentials, and the final drive, which may be drive wheels, a continuous track, or a propeller. A transmission is an assembly that provides speed and torque conversions from a power source to an output shaft. One example of the transmission is a gear system that uses a series of different gears and gear trains. The gears have different ratios that are used at different speeds and power levels. Another example of the transmission is a continuously variable transmission (CVT).

A CVT is an automatic transmission that can continuously adjust gear ratios within a certain range, in contrast with mechanical transmissions that offer a fixed number of gear ratios. A CVT can provide flexibility for an input shaft to maintain a constant angular velocity, and allow a vehicle to continuously have an optimal gear ratio selected. Typically, a CVT is implemented with various mechanical elements. Some examples of a CVT use a belt-driven system. For example, a conventional CVT replaces the gears with two variable-diameter pulleys, each shaped as a pair of opposing cones, with a metal belt or chain running between the pulleys. One pulley is connected to the engine, and the other is connected to the drive wheels. In other embodiments, a CVT uses a roller/friction system. For example, the system includes discs and rollers that transmit power between the discs. One disc is connected to the engine, and the other disc is connected to the wheels. Between the discs are the rollers that vary the ratio and transfer power from one side to the other. The rollers are movable to contact the discs at varying and distinct diameters, giving various gear ratios.

It can be seen that a new and improved system for a powertrain is needed. Such a system should provide a simplified transmission that removes at least some conventional transmission elements. Such a system should improve torque-handling performance of a CVT transmission and reduce friction wear between a torque source and a transmission medium. The present invention addresses these as well as other problems associated with powertrains or vehicles.

### SUMMARY

One aspect of the present disclosure is directed to a multifunctional rotating element. The multifunctional rotating element includes a body and a plurality of contact elements. The body has an axis of rotation and is configured to rotate about the axis of rotation, and defines a rim portion. The plurality of contact elements are arranged around the rim portion. Each of the contact elements is independently movable between a raised position and a depressed position and biased to the raised position. Each of the contact elements is configured to move to the depressed position when engaged with an engagement object.

In certain embodiments, the multifunctional rotating element is used as a gear assembly. The contact elements include gear tooth elements, and the engagement object includes at least one gear tooth of a second gear configured to mesh with the gear assembly. In certain embodiments, two or more of the plurality of gear tooth elements are displaceable from the raised position to the depressed position to engage the at least one gear tooth of the second gear. The two or more of the plurality of gear tooth elements are in the depressed position to complement a profile of the at least one gear tooth of the second gear. The second gear may include a gear plate rotatable around a second axis of rotation, and a plurality of gear teeth formed on the gear plate and radially outwardly extending from the second axis of rotation such that a width between adjacent gear teeth becomes larger as the gear teeth extend from the second axis of rotation. In certain embodiments, a gear shifting device is provided to move the body relative to the gear plate of the second gear. In certain embodiments, the body is configured as a circular plate and arranged perpendicular to the second gear such that the plurality of gear tooth elements are engaged with the plurality of gear teeth of the second gear. The gear shifting device is configured to radially move the body relative to the second axis of rotation of the second gear while the plurality of gear tooth elements remain engaged with the plurality of gear teeth of the second gear. In certain embodiments, at least one of the gear tooth elements of the gear assembly is engaged with adjacent gear teeth of the second gear at a first position. The gear assembly is at the first position when the body is arranged adjacent the second axis of rotation of the second gear. As the gear assembly moves from the first position to a second position that is further from the second axis of rotation than the first position, the number of gear tooth elements of the gear assembly that are engaged with adjacent gear teeth of the second gear can increases.

In certain embodiments, the multifunctional rotating element is used as a wheel, and the contact elements are configured to contact a ground surface on which the wheel rolls. In certain embodiments, two or more of the plurality of contact elements are displaceable from the raised position to the depressed position to engage the object on the ground surface, the two or more of the plurality of contact elements being in the depressed position to complement a profile of the object. The number of contact elements of the wheel that are engaged with the engagement object on the ground surface can change depending on the profile and size of the engagement object. In certain embodiments, each of the contact elements includes a tire arranged on an outer surface thereof.

Another aspect is a powertrain including an engine, an output shaft connected to a load, and a transmission connected between the engine and the output shaft. The transmission includes a flywheel, a gear assembly, and a gear shifting device. The flywheel includes a gear plate and a plurality of gear teeth. The gear plate is rotatably connected to the engine, and the plurality of gear teeth is formed on the gear plate. The gear assembly is meshed with the flywheel and includes a gear body and a plurality of gear tooth elements. The plurality of gear tooth elements is arranged on a rim portion of the gear body. Each of the gear tooth elements is independently movable between a raised position and a depressed position and biased to the raised position. Each of the gear tooth elements is configured to move to the depressed position when engaged with at least one of the gear teeth of the flywheel. The gear shifting device is configured to move the gear body of the gear assembly relative to the flywheel to change a position at which the gear assembly meshes with the flywheel.

In certain embodiments, two or more of the plurality of gear tooth elements are displaceable from the raised position to the depressed position to engage the at least one gear tooth of the flywheel. The two or more of the plurality of gear tooth elements are in the depressed position to complement a profile of the at least one gear tooth of the flywheel. In certain embodiments, the plurality of gear teeth are formed on the gear plate and extend radially outwardly from a second axis of rotation of the flywheel such that a width between adjacent gear teeth becomes larger as the gear teeth extend from the second axis of rotation. In certain embodiments, the gear body is configured as a circular plate and arranged perpendicular to the gear plate of the flywheel such that the plurality of gear tooth elements of the gear assembly are engaged with the plurality of gear teeth of the flywheel. The gear shifting device is configured to radially move the gear body relative to the second axis of rotation of the second gear while the plurality of gear tooth elements remain engaged with the plurality of gear teeth of the flywheel. In certain embodiments, at least one of the gear tooth elements of the gear assembly is engaged with adjacent gear teeth of the flywheel at a first position. The gear assembly is at the first position when the gear body is arranged adjacent the second axis of rotation of the second gear. The number of gear tooth elements of the gear assembly that are engaged with adjacent gear teeth of the flywheel increases at a second position, which is defined as a position further from the second axis of rotation than the first position.

In certain embodiments, the powertrain further includes a wheel connected to the output shaft. The wheel includes a wheel body and a plurality of contact elements. The wheel body has an axis of rotation and is configured to rotate about the axis of rotation, and defines a rim portion. The contact elements are arranged around the rim portion of the wheel body. Each of the contact elements is independently movable between a raised position and a depressed position and biased to the raised position. Each of the contact elements is configured to move to the depressed position when engaged with an object on a ground surface. In certain embodiments, two or more of the plurality of contact elements are displaceable from the raised position to the depressed position to engage the object on the ground surface. The two or more of the plurality of contact elements are in the depressed position to complement a profile of the object. The number of contact elements of the wheel that are engaged with the object on the ground surface varies depending on the profile of the engagement object. In certain embodiments, each of the contact elements can include a tire arranged on an outer surface thereof.

Yet another aspect of the present invention is a method of operating a continuously variable transmission. The method may include: engaging at least one of a plurality of gear tooth elements arranged on a rim portion of a first circular gear with at least one of a plurality of gear teeth formed on a gear plate of a second circular gear. The first circular gear is arranged perpendicular to the second circular gear, and is configured to rotate about a first axis of rotation. The plurality of gear teeth are arranged to extend radially outwardly from a second axis of rotation such that a width between adjacent gear teeth becomes larger as the gear teeth extend from the second axis of rotation. The method further includes moving the first circular gear radially relative to the second axis of rotation to change a position of the first circular gear on the gear plate of the second circular gear while the gear tooth elements of the first circular gear remain engaged with the gear teeth of the second circular gear.

In certain embodiments, each of the gear tooth elements of the first circular gear is independently movable between a raised position and a depressed position and biased to the raised position. Each of the gear tooth elements is configured to move to the depressed position when engaged with at least one of the gear teeth of the second circular gear.

In certain embodiments, the method further includes moving the first circular gear to a first position on the gear plate of the second circular gear; and moving the first circular gear to a second position on the gear plate of the second circular gear. The second position is defined as a position further from the second axis of rotation than the first position. As the first circular gear moves from the first position to the second position, the number of gear tooth elements of the first circular gear that are engaged with adjacent gear teeth of the second circular gear increases.

These features of novelty and various other advantages that characterize the invention are pointed out with particularity in the claims annexed hereto and forming a part hereof. However, for a better understanding of the invention, its advantages, and the objects obtained by its use, reference should be made to the drawings that form a further part hereof, and to the accompanying descriptive matter, in which there is illustrated and described a preferred embodiment of the invention.

### BRIEF DESCRIPTION OF THE DRAWINGS

FIG. 1 is a schematic view of a first embodiment of a powertrain in accordance with the principles of the present disclosure;

FIG. 2 is a schematic top view of the powertrain shown in FIG. 1;

FIG. 3 is a schematic view of a flywheel used in the powertrain shown in FIG. 1;

FIG. 4 is a schematic view of a multifunctional rotating element used in the powertrain shown in FIG. 1;

FIG. 5 is a schematic view of the flywheel and the multifunctional rotating element shown in FIGS. 3 and 4;

FIG. 6 is a schematic view of gear tooth elements of the gear assembly that mesh with a first profile of a gear tooth of the flywheel;

FIG. 7 is a schematic view of gear tooth elements of the gear assembly that mesh with a second profile of a gear tooth of the flywheel;

FIG. 8 is a schematic view illustrating the gear assembly movement relative to the flywheel;

FIG. 9 is a schematic top view illustrating the gear assembly movement relative to the flywheel;

FIG. 10 is a schematic view showing different positions of the gear assembly relative to the flywheel;

FIGS. 11A-11D are schematic views illustrating embodiments of different engagements of the gear assembly with the flywheel; and

FIG. 12 is a schematic view of the multifunctional rotating element used as a wheel;

FIG. 13 is a schematic view of another embodiment of a powertrain in accordance with the principles of the present disclosure;

FIG. 14 is a detail view of the powertrain of FIG. 13;

FIG. 15 is a schematic top view of a multifunctional rotating element used in the powertrain shown in FIG. 13; and

FIG. 16 is a schematic bottom view of the multifunctional rotating element of FIG. 15.

FIG. 17 is a schematic view of yet another embodiment of a flywheel and a multifunctional rotating element.

FIG. 18 is a schematic top view of the flywheel of FIG. 17.

### DETAILED DESCRIPTION

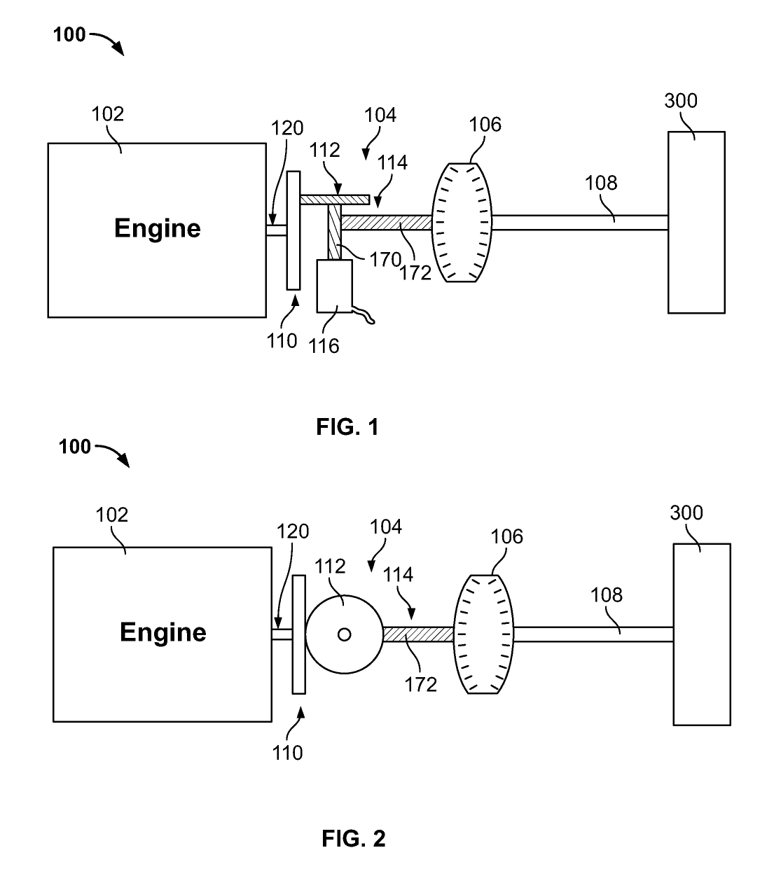

Referring now to the drawings and in particular to FIGS. 1 and 2, there is shown a powertrain system, generally designated (100). The powertrain system (100) includes an engine (102), a continuously variable transmission (CVT) (104), a torque converter (106), an output shaft (108), and at least one wheel (300). The engine (102) can be of any type, such as combustion engines, electric motors, pneumatic motors, and hydraulic motors. The CVT (104) includes a flywheel (110), a gear assembly (112), a power transfer unit (114), and a gear shifting device (116).

As described herein below, the principles and configurations of a multifunctional rotating element (200) in accordance with the present disclosure are applied to the gear assembly (112), the wheel (300), and/or the flywheel (110). An example of the gear assembly (112) and associated elements is described and illustrated with reference to FIGS. 1-10 and 11A-11D. An example of the wheel (300) and associated elements is described and illustrated with reference to FIGS. 1, 2, 4, 5 and 12. Although the present disclosure primarily illustrates the powertrain system (100) including both the gear assembly (112) and the wheel (300) that are implemented using the principles and configurations of the multifunctional rotating element, it is noted that only one of the gear assembly (112) and the wheel (300) is configured with the multifunctional rotating element in the powertrain (100).

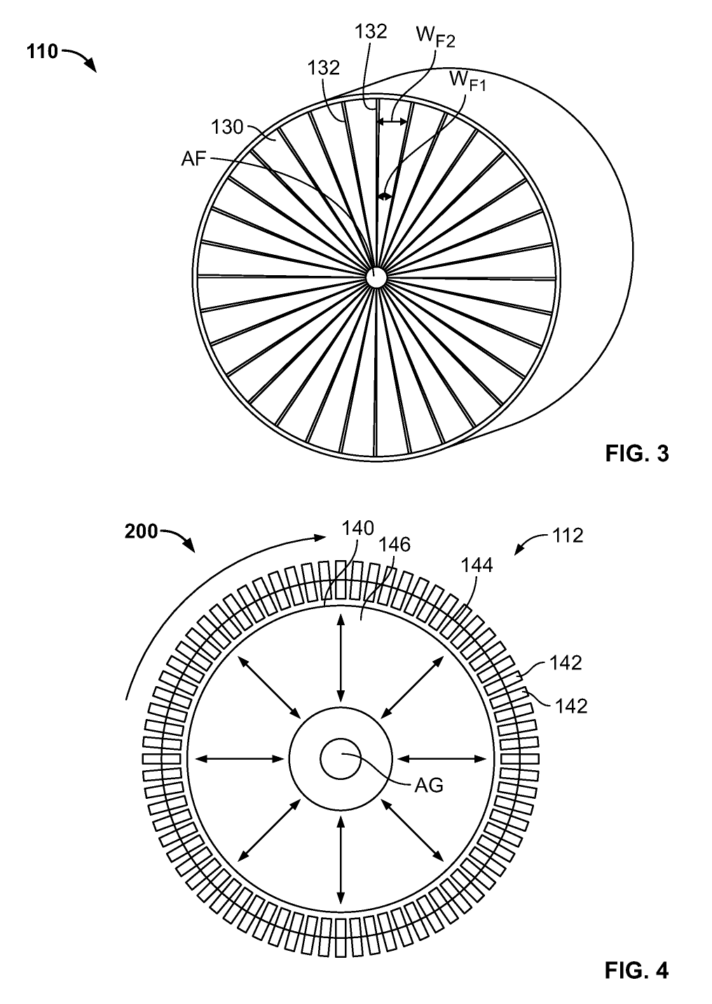

Referring to FIGS. 1 and 2, the flywheel (110) is rotatably connected to the engine (102) via a crankshaft (120) that is configured to convert an output, such as reciprocating motion of pistons of the engine (102) to rotational motion of the flywheel (110). As illustrated in FIG. 3, the flywheel (110) is configured as a circular plate having a gear face (130) and is rotatable around an axis of rotation A_{F}. In some embodiments, the crankshaft (120) is connected to the side opposite to the gear face (130) at the axis of rotation A_{F}. A plurality of gear teeth (132) are formed on the gear face (130) around the axis of rotation A_{F}. The gear teeth (132) are formed to extend radially outwardly from the axis of rotation A_{F}. A width W_{F} between adjacent gear teeth (132) becomes wider as the gear teeth (132) extend from the axis of rotation A_{F}. In some embodiments, the width W_{F} is defined as a distance between a center line of one gear tooth (132) and a center line of the adjacent gear tooth (132). For example, a width W_{F1} between the gear teeth (132) closer to the axis of rotation A_{F} is smaller than a width W_{F2} between the same gear teeth (132) further from the axis of rotation A_{F}, as illustrated in FIG. 3. Although it is primarily illustrated that the flywheel (110) has the gear teeth (132) radiating out from the axis of rotation A_{F}, it is also possible that the gear teeth (132) are formed in different patterns on the gear face (130).

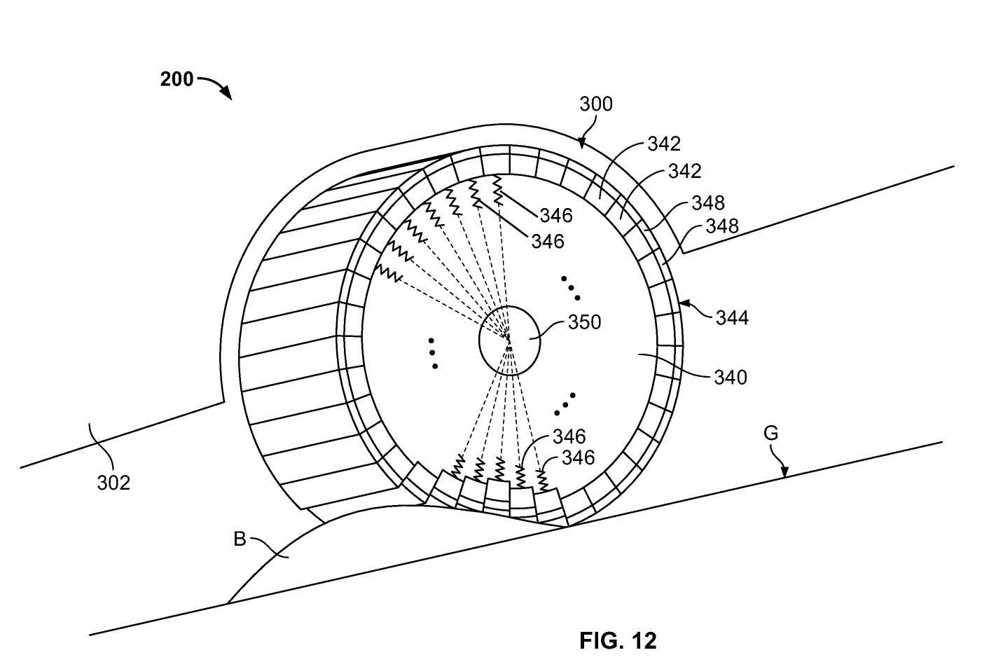

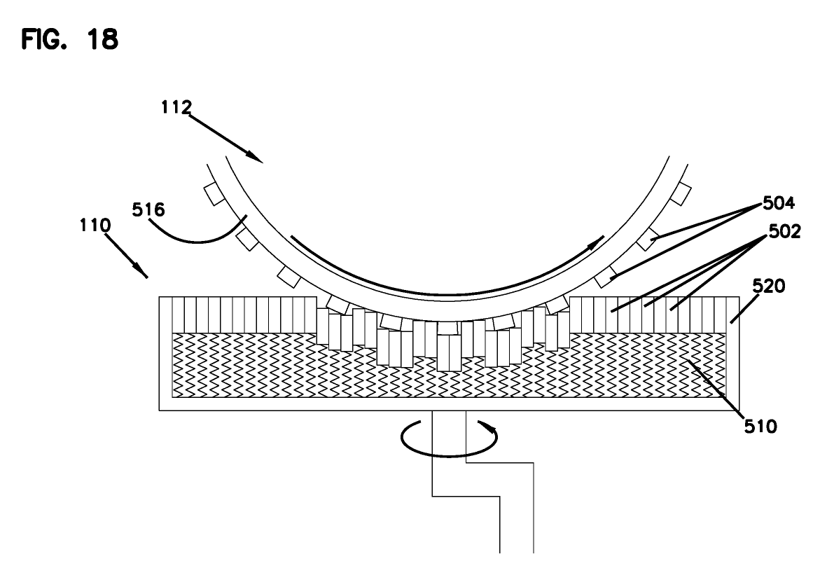

With reference to FIGS. 4-7, an example of the multifunctional rotating element (200) is described. In this example, the multifunctional rotating element (200) is implemented as the gear assembly (112). For clarity, the multifunctional rotating element (200) is described as the gear assembly (112) in FIGS. 1-10 and 11A-11D. As described herein, the multifunctional rotating element (200) will be described as the wheel (300) in FIG. 12, and as the flywheel (110) in FIGS. 17-18.

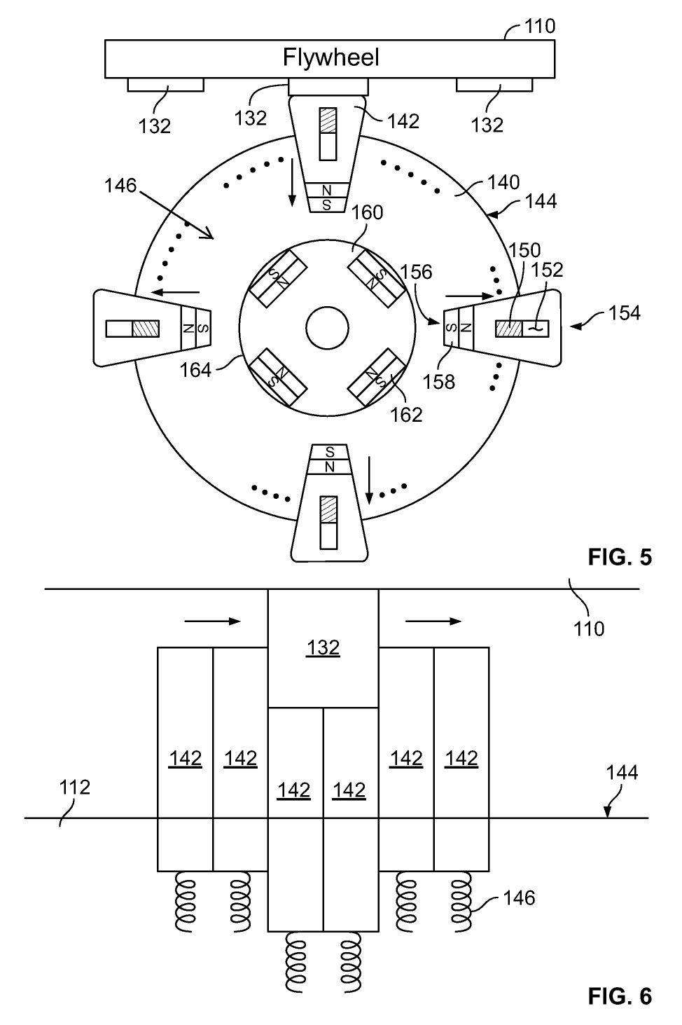

Referring to FIG. 4, the example gear assembly (112) is configured to mesh with the gear teeth (132) of the flywheel (110) in various positions. The gear assembly (112) includes a circular gear body (140) that is rotatable about an axis of rotation A_{G}. The gear body (140) is configured to receive a plurality of gear tooth elements (142) around a rim portion (144). The gear tooth elements (142) are configured to move in and out within a certain range relative to the rim portion (144) of the gear body (140). The gear tooth elements (142) are configured to mesh with the gear teeth (132) of the flywheel (110). As described herein, the gear tooth elements (142) are configured to complementarily mesh with any profiles (e.g., different widths, depths, and positions) of the gear teeth (132) of the flywheel (110). At least one of the gear tooth elements (142) is independently movable between a raised position and a depressed position relative to the rim portion (144), as illustrated in FIGS. 5-7 and 11A-11D. A gear tooth element (142) is in the raised position when the gear tooth element (142) is displaced radially outward relative to the center of the gear assembly, and is in the depressed position when the gear tooth element (142) is displaced radially inward relative to the center of the gear assembly (112).

Each gear tooth element (142) is biased to the raised position by a biasing element (146). The biasing element (146) operates to provide tension against the gear tooth elements (142) so that the gear tooth elements (142) are pushed away from the axis of rotation A_{G} of the gear assembly (112). In some embodiments, the biasing element (146) includes one or more spring elements that are disposed within the gear body (140) and engage the gear tooth elements (142). The biasing element (146) enables the gear tooth elements (142) to maintain contact with the intermeshing gear teeth (132) of the flywheel (110). Since the gear tooth elements (142) of the gear assembly (112) are biased radially outwardly (i.e., to the raised position), the gear tooth elements (142) can return to the raised position when the gear teeth (132) of the flywheel (110) that have been meshed with the gear tooth elements (142) are disengaged as the flywheel (110) and the gear assembly (112) rotate together. The disengaged gear tooth elements (142) remain in the raised position until the gear assembly (112) makes a full rotation to engage the disengaged gear tooth elements (142) with the corresponding gear teeth (132) of the flywheel (110).

Furthermore, the biasing element (146) provides the gear tooth elements (142) with flexibility for accommodating different profiles of the gear teeth (132) that intermesh with the gear tooth elements (142). For example, when the flywheel (110) makes contact with the gear assembly (112), one or more of the gear teeth (132) of the flywheel (110) press down one or more intermeshing gear tooth elements (142) of the gear assembly (112) while the biasing element (146) pushes the intermeshing gear tooth elements (142) against the corresponding gear teeth (132). As such, the biasing element (146) and the plurality of gear tooth elements (142) of the gear assembly (112) ensure that the flywheel (110) and the gear assembly (112) constantly stay synchronized with each other, regardless of the rotational speed of the flywheel (110) and the profiles of the gear teeth (132) of the flywheel (110). Further, this configuration of the gear assembly (112) ensures that, even though the gear teeth (132) of the flywheel (110) and the gear tooth elements (142) of the gear assembly (112) wear down over time, the gear teeth (132) and the gear tooth elements (142) continue to have good contact with each other due to the biasing element (146). Also, if the flywheel (110) becomes damaged and the gear teeth (132) have distorted shapes, the gear tooth elements (142) of the gear assembly (112) can still form around, and mesh with, the damaged gear teeth (132), thereby properly maintaining torque transmission between the flywheel (110) and the gear assembly (112).

Referring to FIG. 5, an example of the gear assembly (112) is described with an example of the biasing element (146) therefor. In the example shown, the biasing element (146) is magnetically configured. The gear body (140) includes a plurality of studs (150) arranged and spaced apart from each other at intervals around the axis of rotation A_{G} of the gear assembly (112). In some embodiments, the studs (150) are integrally molded with the gear body (140). Each gear tooth element (142) includes a channel (152) in a longitudinal direction (i.e., in a direction that the gear tooth element (142) radially moves between the depressed position and the raised position). Each of the studs (150) of the gear body (140) is engaged with the channel (152) of each gear tooth element (142) such that the channel (152) operates to guide the movement of the gear tooth element (142) between the depressed position and the raised position. The configuration of the studs (150) and the channels (152) enables the flywheel (110) to transfer its rotational motion to the linear motions of the gear teeth elements (142) of the gear assembly (112) and then to transfer the linear motions to the rotational movement of the gear body (140) of the gear assembly (112). Furthermore, the cooperation of the studs (150) and the channels (152) can provide a fixed travel length for the path that the gear tooth elements (142) linearly travel in and out along as the gear tooth elements (142) mesh with the gear teeth (132) of the flywheel (110). By containing the studs (150) and at least portions of the gear tooth elements (142) within the gear body (140), the dimension and space of the gear assembly (112) can be saved, and allow room for more gear tooth elements (142). In other embodiments, the studs (150) can be formed on the gear tooth elements (142) and the channels (152) can be correspondingly provided to the gear body (140).

Each gear tooth element (142) has an engaging end (154) exposed to the exterior of the gear body (140) and configured to engage the gear teeth (132) of the flywheel (110). A magnet (158) is arranged at the end (156) opposite to the engaging end (154) of the gear tooth element (142). The opposite polarities of the magnet (158) are radially arranged such that one polarity, such as the southern polarity, faces the axis of rotation A_{G} and the other polarity, such as the northern polarity, is directed radially outwardly. In some embodiments, the magnet (158) can be attached to the opposite end (156) of the gear tooth element (142) while the gear tooth element (142) is made of non-magnetic materials. Within the gear body (140) is a body center magnetic element (160) arranged around the axis of rotation A_{G}. The body center magnetic element (160) has the opposite polarities, and is arranged such that the same polarities of the center magnetic element (160) and the magnet (158) of the gear tooth elements (142) face each other. In some embodiments, the body center magnetic element (160) can be made a single piece of magnetic material. In other embodiments, the body center magnetic element (160) includes a plurality of separate magnets (162) arranged and spaced apart at intervals around the axis of rotation A_{G} within the gear body (140). Since the magnets (158) of the gear tooth elements (142) and the body center magnetic element (160) are arranged to have the like poles facing each other, the body center magnetic element (160) operates to repel the gear tooth elements (142) radially outwardly in the raised position. In some embodiments, the centrifugal force that is generated when the gear assembly (112) rotates can help to bias the gear tooth elements (142) outwardly, in addition to the repelling magnetic forces between the body center magnetic element (160) and the magnets (158) of the gear tooth elements (142).

Moreover, the gear assembly (112) can operate as an electric generator. In this configuration, the gear assembly (112) includes a conductive housing (164) disposed around the body center magnetic element (160). The conductive housing (164) and the body center magnetic element (160) are configured to be stationary while the other part of the gear assembly (112) rotates. As the gear assembly (112) rotates, the magnets (158) of the gear tooth elements (142) pass over the magnets (162). This interaction of the magnets (158, 162) induces an electric field. The electric field is harnessed for various operations in a vehicle. The conductive housing (164), which is made of magnetic materials, is used to gather the electric field. The gear assembly (112) is configured such that the magnets (158) of the gear tooth elements (142) can move close to the conductive housing (164) to generate an electric field, but never come into contact with the conductive housing (164).

Although all of the gear tooth elements (142) are primarily illustrated as being independently movable between the depressed position and the raised position, it is also possible to include at least one of the gear tooth elements (142) that are configured to be fixed or immovable while the other gear tooth elements (142) are movable.

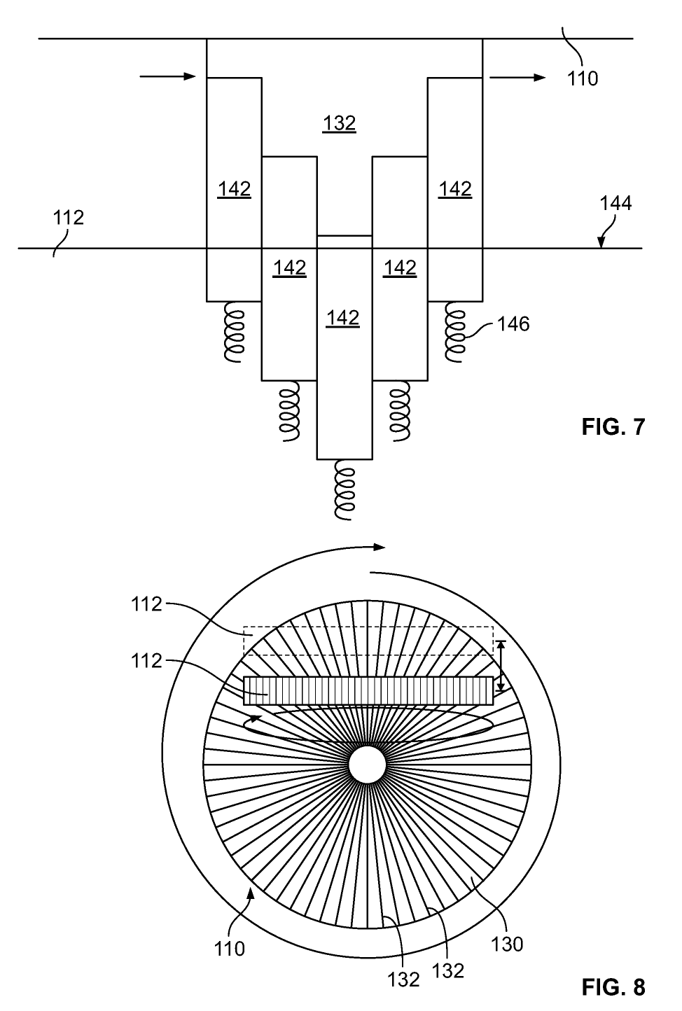

FIGS. 6 and 7 further illustrate that the gear tooth elements (142) of the gear assembly (112) can mesh with different profiles of the gear teeth (132) of the flywheel (110). In some embodiments, one gear tooth element (142) of the gear assembly (112) is pushed down to the depressed position by one gear tooth (132) of the flywheel (110), and thus the one gear tooth element (142) and the one flywheel gear tooth (132) are intermeshed. In other embodiments, a plurality of gear tooth elements (142) can be displaced at least partially inwards by one or more of the flywheel gear teeth (132) as the flywheel (110) comes into contact with the gear assembly (112). For example, as illustrated in FIG. 6, two gear tooth elements (142) can be pushed down by a single flywheel gear tooth (132) so that the single flywheel gear tooth (132) meshes with the two gear tooth elements (142). The gear tooth elements (142) that are in the raised position and adjacent to the gear tooth elements (142) displaced to the depressed position are used to receive the torque of the flywheel (110) and transfer torque to the rotation of the gear assembly (112). Further, as illustrated in FIG. 7, two or more of the gear tooth elements (142) are at least partially pressed inward to an amount that needs to fit different profiles, such as widths, depths, and/or shapes, of the gear teeth (132) of the flywheel (110). For example, in order to complement the shape of a flywheel gear tooth (132) with a non-planar profile, a plurality of gear tooth elements (142) are depressed to different levels to correspond to the profile of the intermeshing gear tooth (132) of the flywheel (110).

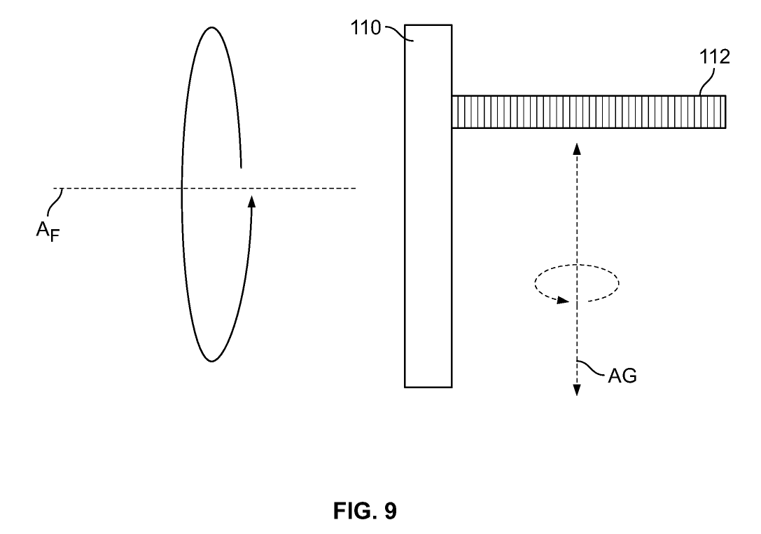

Referring to FIGS. 8 and 9, the gear assembly (112) is movable relative to the flywheel (110) to continuously change gear ratios between the flywheel (110) and the gear assembly (112). As described above, the gear assembly (112) is arranged perpendicularly to the flywheel (110) such that the flywheel gear teeth (132) formed on the gear face (130) are engaged with the gear tooth elements (142) arranged on the rim portion (144) of the gear assembly (112). The gear assembly (112) can move radially between an innermost position adjacent to the axis of rotation A_{F} of the flywheel (110) and an outermost position adjacent an outer circumference of the flywheel (110). In some embodiments, the gear shifting device (116) is connected to the gear assembly (112) and operated to continuously move the gear assembly (112) between the first and second positions relative to the flywheel (110).

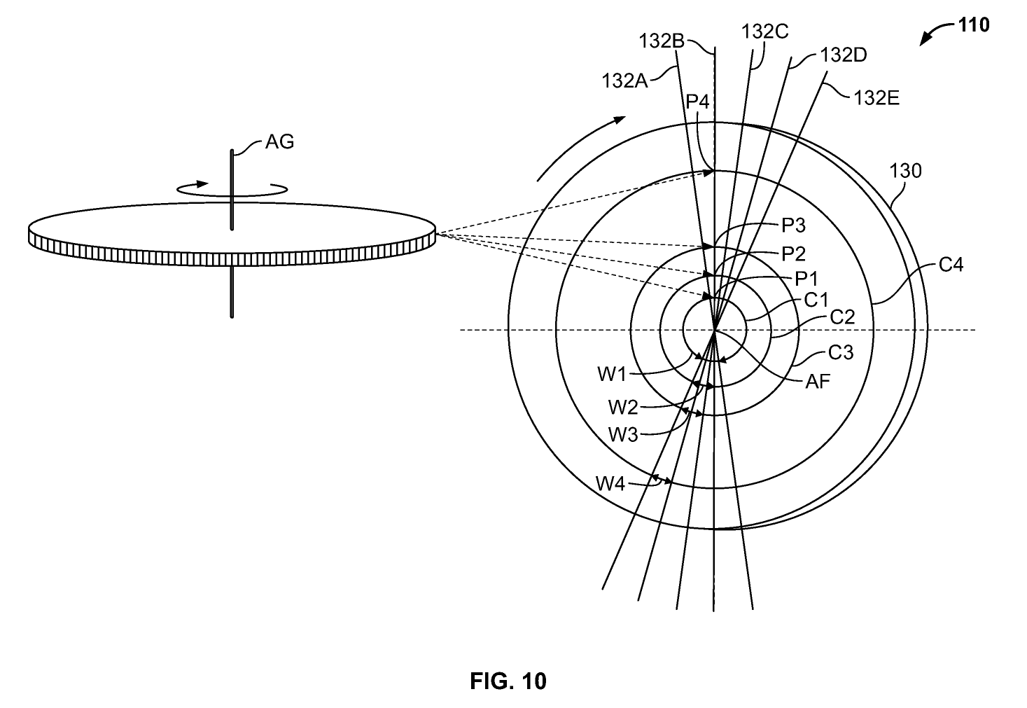

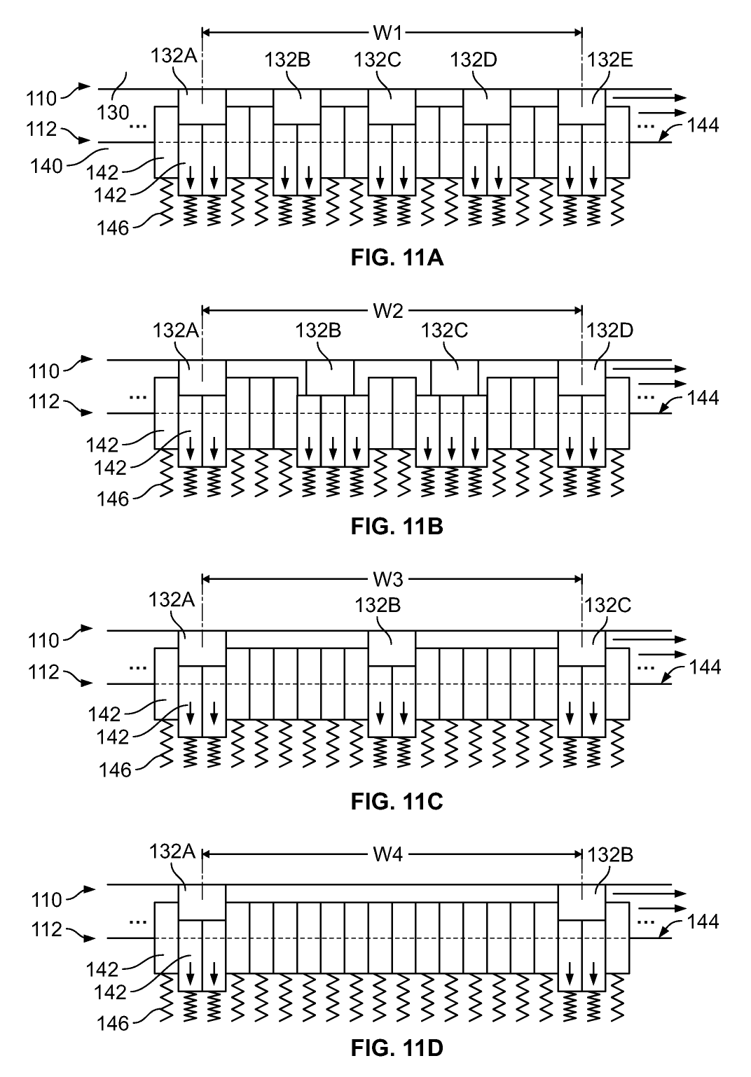

FIGS. 10 and 11A-D schematically illustrate examples of different engagements of the gear assembly (112) with the flywheel (110) at different positions of the gear assembly (112) relative to the flywheel (110). By way of example, FIG. 10 illustrates that the gear assembly (112) can selectively engage the flywheel (110) at four different positions (P1-P4). However, the gear assembly (112) can be arranged at any location on the flywheel (110) to the extent the gear tooth elements (142) of the gear assembly (112) mesh with the gear teeth (132) of the flywheel (110).

Where the gear assembly (112) engages the flywheel (110) at a first position (P1), the gear tooth elements (142) of the gear assembly (112) mesh with the gear teeth (132) of the flywheel (110) arranged along a first circular path (C1) as the flywheel (110) rotates. FIG. 11A illustrates an example engagement of the flywheel gear teeth (132), such as five gear teeth (132A, 132B, 132C, 132D, and 132E)) of the flywheel (110) with the gear tooth elements (142) of the gear assembly (112, when the gear assembly (112) is at the first position (P1). Where the gear assembly (112) engages the flywheel (110) at a second position (P2), the gear tooth elements (142) of the gear assembly (112) mesh with the gear teeth (132) of the flywheel (110) arranged along a second circular path (C2) as the flywheel (110) rotates. FIG. 11B illustrates an example engagement of the flywheel gear teeth (132), such as four gear teeth (132A, 132B, 132C, and 132D), of the flywheel (110) with the gear tooth elements (142) of the gear assembly (112) when the gear assembly (112) is at the second position (P2). Where the gear assembly (112) engages the flywheel (110) at a third position (P3), the gear tooth elements (142) of the gear assembly (112) mesh with the gear teeth (132) of the flywheel (110) arranged along a third circular path (C3) as the flywheel (110) rotates. FIG. 11C illustrates an example engagement of the flywheel gear teeth (132), such as three gear teeth (132A, 132B, and 132C), of the flywheel (110) with the gear tooth elements (142) of the gear assembly (112) when the gear assembly (112) is at the third position (P1). Where the gear assembly (112) engages the flywheel (110) at a fourth position (P4), the gear tooth elements (142) of the gear assembly (112) mesh with the gear teeth (132) of the flywheel (110) arranged along a fourth circular path (C4) as the flywheel (110) rotates. FIG. 11D illustrates an example engagement of the flywheel gear teeth (132) with two gear teeth (132A and 132B) of the flywheel (110) with the gear tooth elements (142) of the gear assembly (112) when the gear assembly (112) is at the fourth position.

The positions of the gear assembly (112) relative to the flywheel (110) also determine different gear ratios therebetween. As the flywheel (110) is driven by the engine (102), the gear assembly (112) rotates at different speeds based on a location that the gear assembly (112) is engaged with the flywheel (110). For example, as the gear assembly (112) is positioned close to the center, the axis of rotation A_{F}, of the flywheel (110), the flywheel (110) needs to make more revolutions to complete a revolution of the gear assembly (112). By way of example, it is assumed that the flywheel (110) and the gear assembly (112) have the same diameter (i.e., the same circumference), and the gear assembly (112) is rotated on a circular path on the flywheel (110) along which the gear assembly (112) engages as the flywheel (110) rotates. If the circular path on the flywheel (110) is the same in length as the circumference of the gear assembly (112) so that the gear assembly (112) is arranged at or adjacent the outer edge of the flywheel (110), the gear ratio between the flywheel (110) and the gear assembly (112) is about 1:1. When the gear assembly (112) moves toward the center of the flywheel (110) to a point where the length of the circular path is one third of the circumference of the gear assembly (112), the gear ratio becomes about 3:1. Therefore, the flywheel (110) needs to rotate three times to rotate the gear assembly (112) once.

Referring again to FIGS. 1 and 2, the CVT (104) further includes the power transfer unit (114) and the gear shifting device (116). In the example shown, the power transfer unit (114) is configured to transfer the rotation of the gear assembly (112) to the torque converter (106). In some embodiments, the power transfer unit (114) includes a gear assembly shaft (170) and a transfer shaft (172). The gear assembly shaft (170) is connected to the axis A_{G} of the gear assembly (112) and is configured to engage the transfer shaft (172) to transmit the rotation of the gear assembly (112) to the transfer shaft (172). The gear assembly shaft (170) may be a shaft with gear teeth running along its length. Such a transfer shaft (172) has gear teeth formed around the shaft, which correspond to the gear teeth formed on the gear assembly shaft (170). The transfer shaft (172) is engaged with, or coupled to, the torque converter (106). The gear assembly shaft (170) and the transfer shaft (172) can be configured in various gear arrangements, such as worm gears, bevel gears, helical gears, and other suitable gear types. In other embodiments, the power transfer unit (114) includes one or more gears of various types, which intermesh in various manners or includes other types of torque transfer devices.

The gear shifting device (116) operates to move the gear assembly (112) relative to the flywheel (110) while the gear tooth elements (142) of the gear assembly (112) remain engaged with the gear teeth (132) of the flywheel (110). The gear shifting device (116) can be connected to the gear assembly (112) through the gear assembly shaft (170). The gear shifting device (116) may be of any common type, such as hydraulic actuator, electric motor, and any other suitable device that facilitates the linear and rotational movements of the gear assembly (112).

Referring again to FIGS. 1 and 2, the powertrains (100) further includes the torque converter (106) and the output shaft (108). The torque converter (106) is configured to transfer the power of the CVT (104), such as the transfer shaft (172), to a rotating driven load. The torque converter (106) also operates to disconnect the power generated by the engine (102) from the output shaft (108). The torque converter (106) can be of various types, such as hydraulic systems or mechanical systems. In some embodiments, the torque converter (106) is replaced by a mechanical clutch.

The output shaft (108) is connected to a load and configured to transfer power from the CVT (104) to the load. The load can be of various types, such as drive wheels, continuous tracks, or propellers.

Referring to FIG. 12, the multifunctional rotating element (200) is implemented as a wheel, designated (300). The wheel (300) can be coupled to an output shaft, such as the output shaft (108) above, of a powertrain, such as the powertrain (100) above, of a vehicle (302). The vehicle (302) can be of various types, such as motor vehicles including, but not limited to, motorcycles, cars, trucks, buses, agricultural equipment, construction equipment, riding mowers, and golf carts, railed vehicles including trains and trams, wagons, bicycles, aircraft, spacecraft and other wheeled vehicles.

The wheel (300) is configured similarly to the gear assembly (112) and can replace typical pneumatic tires supported by air pressure. The wheel (300) includes a wheel body (340) configured to receive a plurality of contact elements (342) depressed around a rim portion (344). Similar to the gear tooth elements (142), the contact elements (342) are configured to move in and out within a certain range relative to the wheel body (340) around the rim portion (344). The wheel (300) further includes a biasing element (346) to bias the contact elements (342) radially outwardly. For example, the biasing element (346) is configured to provide tension against the contact elements (342) so that the contact elements (342) are pushed away from a wheel hub (350). The biasing element (346) can be configured similarly to the biasing element (146).

The contact elements (342) are configured to be pushed in radially inwards as they ride over an object (B), such as a protruded, uneven, or irregular surface, or obstacles on a ground surface (G), on which the wheel (300) rolls. One or more of the contact elements (342) are configured to be depressed to complement the shape of the object (B) on the ground surface (G), so that the wheel (300) is at least partially deformed around the object (B). As such, the depressed contact elements (342) can function as a shock absorber for the vehicle (302). Further, the contact elements (342) have increased contact area and can provide more traction on the ground surface (G).

In some embodiments, an outer surface of each contact element (342) can be at least partially covered with a tire (348) that can provide additional traction and protection of the contact element (342). The tire (348) can be made of various materials, such as a composition including an elastomer (such as synthetic rubber), natural rubber, carbon black, and other chemical compounds. The tire (348) can have treads thereon for additional traction. In some embodiments, the tire (348) is provided to each contact element (342) separately. In other embodiments, the tire (348) is formed in a single circular piece and provided on all of the contact elements (342) together around the entire rim portion (344).

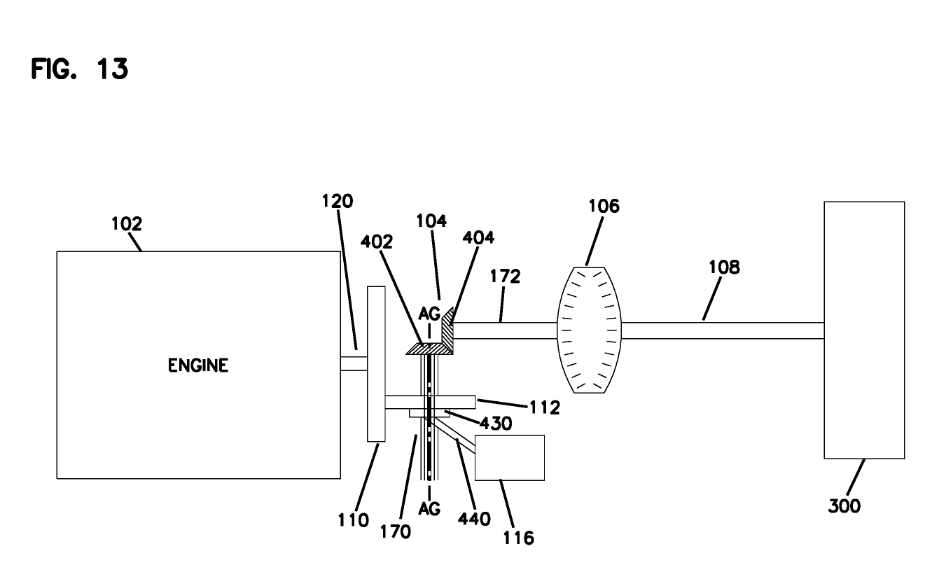

Referring to FIGS. 13-16, there is shown a powertrain system (100) according to another exemplary embodiment of the present disclosure. The powertrain system (100) in this configuration is similarly configured as the powertrain system in FIGS. 1-12. Where like or similar features or elements are shown, the same reference numbers will be used where possible, and the description with reference to FIGS. 1-12 is hereby incorporated by reference for the powertrain system (100) shown in FIGS. 13-16. The following additional description will be limited primarily to the differences from the example described in FIGS. 1-12.

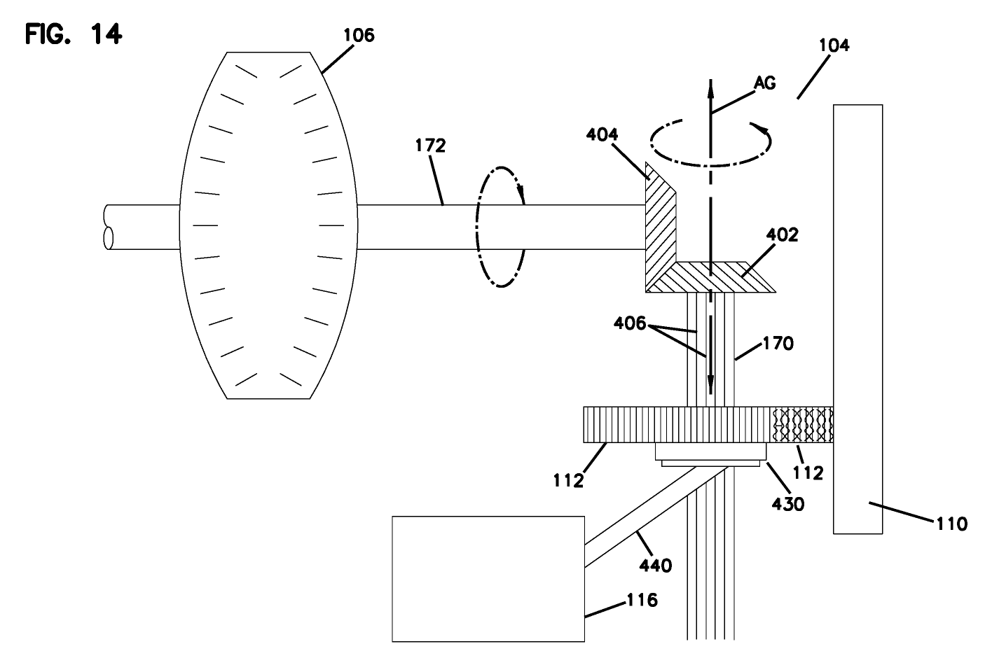

As shown in FIGS. 13 and 14, the gear assembly shaft (170) and the transfer shaft (172) are coupled at the ends thereof. In some examples, bevel gears (402, 404) are provided to the mating ends of the gear assembly shaft (170) and the transfer shaft (172) to couple the gear assembly shaft (170) and the transfer shaft (172).

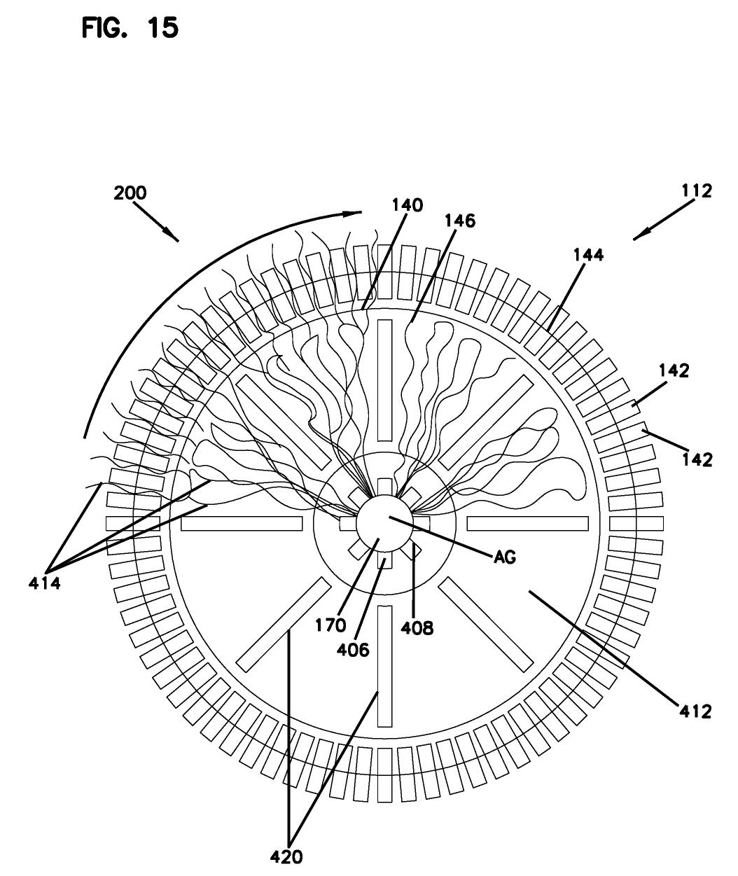

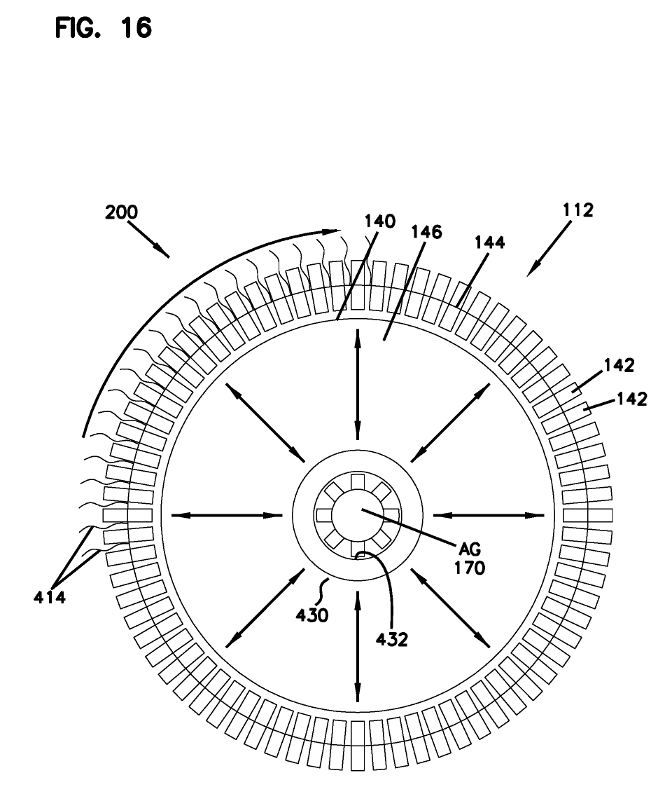

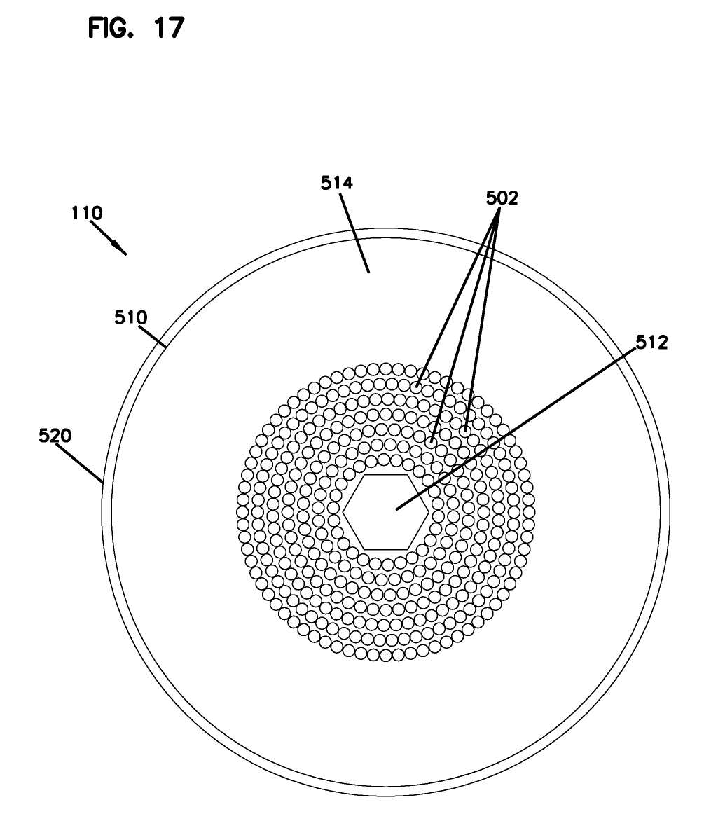

The gear assembly (112) is configured to move relative to the gear assembly shaft (170) along an axis of rotation of the gear assembly shaft (170). The gear assembly shaft (170) is meshed with the gear assembly (112) such that the gear assembly (112) moves along the gear assembly shaft (170) while rotating together with the gear assembly shaft (170). In some examples, as shown in FIGS. 15 and 16, the gear assembly shaft (170) includes longitudinal teeth (406) extending at least partially along the length of the gear assembly shaft (170), and the gear assembly (112) has a center bore (408) shaped to be complementarily engaged with the longitudinal teeth (406) of the gear assembly shaft (170).

In the example shown, the gear assembly shaft (170) is configured to rotate together with the gear assembly (112) about the axis of rotation A_{G}. However, the gear assembly shaft (170) itself does not move along the axis of rotation A_{G} and remains at a same location relative to other components, such as the flywheel (110) and the transfer shaft (172). The gear shifting device (116) is connected to the gear assembly (112) and configured to move the gear assembly (112) along the gear assembly shaft (170) to change a position of the gear assembly (112) relative to the flywheel (110) while the gear tooth elements (142) of the gear assembly (112) remain engaged with the gear teeth (132) of the flywheel (110).

With reference to FIGS. 15 and 16, another embodiment of the multifunctional rotating element (200) is described. In this example, the multifunctional rotating element (200) is implemented as the gear assembly (112). For clarity, the multifunctional rotating element (200) is described as the gear assembly (112). As described herein, the multifunctional rotating element (200) is also implemented as the wheel (300) in FIG. 12, or as the flywheel (110) in FIGS. 17 and 18.

Referring to FIGS. 15 and 16, the gear assembly (112) is described in accordance with another exemplary embodiment of the present disclosure. In this example, the gear assembly (112) includes a fluid chamber (412) defined in a body of the gear assembly (112), and fluid (414) is supplied to the fluid chamber (412). The fluid (414) can function as the biasing element (146) for biasing the gear tooth elements (142) to their raised position. The fluid (414) can be solely used as the biasing element (146), or can be used together with other types of the biasing element (146), such as the spring elements and the magnetic mechanism as described herein.

In some examples, the fluid (414), such as oil, can exit the fluid chamber (412) of the gear assembly (112) through gaps or holes between the gear tooth elements (142) while providing pressure against the bases of the gear tooth elements (142) to keep the gear tooth elements (142) at their outer positions. The rotation of the gear assembly (112) causes a showering effect from the fluid (414) exiting the rotating gear assembly (112), thereby allowing the fluid (414) to lubricate associated components in the powertrain (100), such as the interface between the flywheel (110) and the gear assembly (112). As such, the fluid (414) drawn to the fluid chamber (412) can accomplish not only as the biasing element (146) but also be a lubricant for various parts in the powertrain (100). The fluid (414) can be provided to the fluid chamber (412) in various manners.

In some examples, a fluid pump is used to supply the fluid (414) to the fluid chamber (412). The fluid (414) can be transferred to the fluid chamber (412) through a passage defined in the gear assembly shaft (170). In other examples, the fluid (414) can be provided to the fluid chamber (412) in other fluid transfer means. As shown in FIG. 15, which schematically illustrates a top and internal view of the gear assembly (112), the gear assembly (112) is meshed with the longitudinal teeth (406) of the gear assembly shaft (170) so that the gear assembly (112) transfers torque to the gear assembly shaft (170) while allowing free vertical movement of the gear assembly (112) that slides along the gear assembly shaft (170).

The gear assembly (112) may include a plurality of splines (420) in the body of the gear assembly (112). The splines (420) radially extend between the center of the gear assembly (112) and the gear tooth elements (142). The splines (420) can direct fluid flow and improve the structural integrity of the gear assembly body or housing. The pressure of the fluid (414) provided from the inside of the gear assembly housing can help bias the gear tooth elements (142) toward their outward positions, as well as lubricating various parts.

Referring to FIG. 16, which schematically illustrates the bottom of the gear assembly (112), the fluid (414) is shown to exit the gear assembly (112) through gaps between the gear tooth elements (142). In other examples, oil-exiting-spaces can be placed in other locations on the gear assembly (112). As shown in FIGS. 13, 14, and 16, a bearing element (430) is provided to enable the gear assembly (112) to freely rotate while the gear shifting device (116) controls a position (e.g., a vertical movement) of the gear assembly (112) relative to the flywheel (110) to adjust gear ratios. For example, the gear shifting device (116) includes a supporting device (440), such as an arm, extending to the gear assembly (112) to move the gear assembly (112) along the axis of rotation A_{G}. In some examples, the bearing element (430) is arranged between a free end of the supporting device (440) and the gear assembly (112) such that the gear assembly (112) rotates freely while being supported by the supporting device (440) for vertical movement for selecting gear ratios. The bearing element (430) is configured so that it does not interfere with rotation of the gear assembly (112) relative to the gear assembly shaft (170). For example, as shown in FIG. 16, the bearing element (430) has a bore (432) through which the gear assembly shaft (170) is freely rotatable relative to the bearing element (430) and/or the gear assembly (112) (e.g., the bearing element (430)) is configured not to contact the gear assembly shaft (170).

Referring still to FIGS. 15 and 16, the fluid (414) is shown to exit the gear assembly (112), keeping the gear tooth elements (142) biased radially outwardly. The bearing element (430) is attached to the base of the gear assembly (112) without being in contact with the gear assembly shaft (170). In other examples, the bearing element (430) is configured to contact with the gear assembly shaft (170). The gear shifting device (116) is configured to control the linear movement of the gear assembly (112) to select a desired gear ratio via the flywheel (110). The arm (440) of the gear shifting device (116) is coupled to the bearing element (430) and configured to support the bearing element (430). The gear assembly shaft (170) runs through the center of the gear assembly (112) and the bearing element (430). The splines or teeth (406) extend along the length of the gear assembly shaft (170) so as to be meshed with the body or housing of the gear assembly (112) at the center so that the rotation of the gear assembly (112) is transferred to the gear assembly shaft (170). With this configuration, the gear assembly shaft (170) and the transfer shaft (172) can be simply coupled by using bevel gears (402, 404). In this configuration, the gear shifting device (116) is configured to move the gear assembly (112) and does not need to move the gear assembly shaft (170).

Referring to FIGS. 17 and 18, there is shown another exemplary embodiment of the flywheel (110) and the gear assembly (112) meshing with the flywheel (110). In this embodiment, the flywheel (110) includes a plurality of retractable gear teeth (502) on the face of the flywheel (110) and the gear assembly (112) includes a set of fixed gear teeth (504) on the circumference of the gear assembly (112). In this embodiment, the flywheel (112) works as an example of the multifunctional rotating element (200). Where like or similar features or elements are shown, the same reference numbers will be used where possible, and the description with reference to FIGS. 1-16 is hereby incorporated by reference for the flywheel (110) and the gear assembly (112) shown in FIGS. 17 and 18. The following additional description will be limited primarily to the differences from the example described in FIGS. 1-16.

As illustrated in FIG. 17, the flywheel (110) includes a flywheel housing (510) configured to support the plurality of retractable gear teeth (502). The flywheel housing (510) may include a crankshaft connection element (512) configured to connect the crankshaft (120). In some embodiments, the crankshaft connection element (512) has a polygonal cross section into which a correspondingly-shaped end of the crankshaft (120) fits. In the illustrated embodiment, the crankshaft connection element (512) is shaped as a hexagonal nut. Other configurations are also possible in other embodiments.

The retractable gear teeth (502) are configured similarly to the gear tooth elements (142), as described herein. Therefore, the description with regard to the configurations, principles, functionality, and operations of the gear tooth elements (142) and associated components thereof is applicable to the retractable gear teeth (502). The retractable gear teeth (502) can be arranged in various patterns on the face (514) of the flywheel housing (510). The retractable gear teeth (502) can be arranged such that the gear assembly (112) meshes with the retractable gear teeth (502) of the flywheel (110) in any position or orientation along the axis of rotation A_{G}.

In some embodiments, as the flywheel (110) is configured to include the retractable gear teeth (502) on the face (514) thereof, the gear assembly (112) can have a plurality of fixed gear teeth (504) on a perimeter or rim (516) of the gear assembly (112). The fixed gear teeth (504) are configured similarly to any known gear teeth that are immovable. The fixed gear teeth (504) can be of any profile because the retractable gear teeth (502) are retractable to accommodate various shapes or profiles of mating gear teeth, as illustrated in FIGS. 6, 7 and 11A-11D. In other embodiments, the gear assembly (112) may include a plurality of gear tooth elements (142) as described herein above so that both the flywheel (110) and the gear assembly (112) have retractable gear teeth.

As illustrated in FIG. 18, when the gear assembly (112) having fixed gear teeth (504) contacts with the retractable gear teeth (502) of the flywheel (110), the fixed gear teeth (504) mesh with, and depress, the retractable gear teeth (502) (which are biased to their raised positions) in the same or similar manner as described in FIGS. 11A-11D. As the crankshaft (120) transfers torque into the flywheel (110), the flywheel (110) transfers torque to the gear assembly (112) via meshing gear teeth. The retractable gear teeth (502) on the flywheel (110) are configured to transfer torque acted upon the teeth (502) to one or more of the subsequent teeth (502) until the torque exerted on the teeth reaches the outer supporting wall (520) of the flywheel housing (510). The torque is transferred between the teeth (502) by being exerted on the lateral sides of the teeth (502), and such lateral torque is eventually transferred to the supporting wall (520) of the flywheel housing (510). Since the supporting wall (520) is structurally stronger than each of the teeth (502), the supporting wall (520) contributes to torque transferring between the flywheel (110) and the gear assembly (112). In the illustrated embodiments, the supporting wall (520) is shown as a peripheral wall of the flywheel housing (510). In addition or alternatively, the flywheel housing (510) includes one or more supporting walls arranged any locations of the flywheel housing (510) to the extent that such supporting walls do not interfere with functionality (e.g., torque transfer) of the flywheel.

Where the multifunctional rotating element in accordance with the present disclosure is used as a gear assembly, the gear assembly can provide infinite gear ratios, smooth acceleration and deceleration. Such smooth acceleration and deceleration are especially important when acceleration and deceleration happen frequently, such as in stop and go traffic. Moreover, the system achieves faster acceleration without gear-shifting lag time. In addition, the gear assembly of the present disclosure can improve power efficiency of an engine from zero speed all the way up to the vehicle's maximum speed. Further, the gear assembly of the present disclosure can increase fuel efficiency and vehicle performance, and provide longer transmission life and easy maintenance.

Moreover, the CVT in accordance with the present disclosure simplifies a transmission by removing at least some conventional transmission elements, such as belts, chains, and/or pulleys. In particular, the parts of the CVT of the present disclosure last longer than comparable parts, which require constant replacement in conventional belt-driven systems or roller/friction systems. For example, belt-driven CVTs typically need steel banding in their belts to withstand the forces pushed upon them to prevent the belts from shredding. The CVT belts typically wear faster than all of the other belts used in vehicles because of the amount of stress and friction they experience. Friction-based CVTs last only until there remains adequate friction to propel the vehicle. Also, friction-based CVTs are prone to transmission slipping because, when accelerated, the engine is more powerful than the amount of friction in the CVT.

Furthermore, the CVT of the present disclosure is much easier to maintain because of simple and reliable design and construction. For example, the gears are easy to assemble and disassemble and easy to access for maintenance. The CVT according to the present disclosure can be manufactured at lower costs, and take up less space and weight in the vehicle. The CVT of the present disclosure further improve efficiency in power transfer between components.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A multifunctional rotating element comprising:
a body having an axis of rotation and configured to rotate about the axis of rotation, the body defining a rim portion; and
a plurality of contact elements arranged around the rim portion, each of the contact elements independently movable between a raised position and a depressed position and configured to move to the depressed position when engaged with an object; and
a biasing element configured to bias the plurality of contact elements to the raised position.

2. The multifunctional rotating element of claim 1, wherein:
the multifunctional rotating element includes a gear assembly;
the contact elements include gear tooth elements; and
the multifunctional rotating element further including an object, the object including at least one gear tooth of a second gear, the second gear configured to mesh with the gear assembly.

3. The multifunctional rotating element of claim 2, wherein two or more of the plurality of gear tooth elements are displaceable from the raised position to the depressed position to engage the at least one gear tooth of the second gear, the two or more of the plurality of gear tooth elements being in the depressed position to be complementary to a profile of the at least one gear tooth of the second gear.

4. The multifunctional rotating element of claim 3, wherein the second gear comprises:
a gear plate rotatable around a second axis of rotation; and
a plurality of gear teeth formed on the gear plate and radially outwardly extending from the second axis of rotation, wherein a width between adjacent gear teeth becomes larger as the gear teeth extend from the second axis of rotation.

5. The multifunctional rotating element of claim 4, further comprising:
a gear shifting device configured to move the body relative to the gear plate of the second gear.

6. The multifunctional rotating element of claim 5, wherein:
the body is configured as a circular plate and arranged perpendicular to the second gear such that the plurality of gear tooth elements are engaged with the plurality of gear teeth of the second gear; and
the gear shifting device is configured to radially move the body relative to the second axis of rotation of the second gear while the plurality of gear tooth elements remain engaged with the plurality of gear teeth of the second gear.

7. The multifunctional rotating element of claim 5, wherein:
at least one of the gear tooth elements of the gear assembly is engaged with adjacent gear teeth of the second gear at a first position, wherein the gear assembly is at the first position when the body is arranged adjacent the second axis of rotation of the second gear, and
a number of the gear tooth elements of the gear assembly engaged with adjacent gear teeth of the second gear increases at a second position, the second position defined as a position further from the second axis of rotation than the first position.

8. The multifunctional rotating element of claim 2, wherein:
the multifunctional rotating element includes a wheel; and
the contact elements are configured to contact a ground surface on which the wheel rolls.

9. The multifunctional rotating element of claim 8, wherein:
the object includes an object on the ground surface; and
two or more of the plurality of contact elements are displaceable from the raised position to the depressed position to engage the object on the ground surface, the two or more of the plurality of contact elements being in the depressed position to be complementary to a profile of the object; and
a number of the contact elements of the wheel engaged with the object on the ground surface varies depending on the profile of the object.

10. The multifunctional rotating element of claim 8, wherein each of the contact elements includes a tire arranged on an outer surface thereof.

11. A powertrain comprising:
an engine;
an output shaft connected to a load; and
a transmission connected between the engine and the output shaft, the transmission comprising:
a flywheel including a gear plate and a plurality of gear teeth, the gear plate rotatably connected to the engine, and the plurality of gear teeth formed on the gear plate;
a gear assembly meshed with the flywheel, the gear assembly including a round gear body having a rotational axis and a plurality of gear tooth elements, the plurality of gear tooth elements arranged on a rim portion of the gear body, each of the gear tooth elements independently movable between a raised position and a depressed position and biased to the raised position, each of the gear tooth elements configured to move to the depressed position when engaged with at least one of the gear teeth of the flywheel; and
a gear shifting device configured to move the gear body of the gear assembly relative to the flywheel to change a position at which the gear assembly meshes with the flywheel.

12. The powertrain of claim 11, wherein two or more of the plurality of gear tooth elements are displaceable from the raised position to the depressed position to engage the at least one gear tooth of the flywheel, the two or more of the plurality of gear tooth elements being in the depressed position to complement a profile of the at least one gear tooth of the flywheel.

13. The powertrain of claim 11, wherein the plurality of gear teeth are formed on the gear plate and radially outwardly extend from a second axis of rotation of the flywheel such that a width between adjacent gear teeth becomes larger as the gear teeth extend from the second axis of rotation.

14. The powertrain of claim 13, wherein:
the gear body is configured as a circular plate and arranged perpendicular to the gear plate of the flywheel such that the plurality of gear tooth elements of the gear assembly are engaged with the plurality of gear teeth of the flywheel; and
the gear shifting device is configured to radially move the gear body relative to the second axis of rotation of the second gear while the plurality of gear tooth elements remain engaged with the plurality of gear teeth of the flywheel.

15. The powertrain of claim 13, wherein:
at least one of the gear tooth elements of the gear assembly is engaged with adjacent gear teeth of the flywheel at a first position, wherein the gear assembly is at the first position when the gear body is arranged adjacent the second axis of rotation of the second gear, and
as the gear assembly moves from the first position to a second position further from the second axis of rotation than the first position, a number of the gear tooth elements of the gear assembly engaged with adjacent gear teeth of the flywheel increases.

16. The powertrain of claim 11, further comprising:
a wheel connected to the output shaft, the wheel including:
a wheel body having an axis of rotation and configured to rotate about the axis of rotation, the wheel body defining a rim portion; and
a plurality of contact elements arranged around the rim portion of the wheel body, each of the contact elements independently movable between a raised position and a depressed position and biased to the raised position, each of the contact elements configured to move to the depressed position when engaged with an object on a ground surface.

17. The powertrain of claim 16, wherein:
two or more of the plurality of contact elements are displaceable from the raised position to the depressed position to engage the object on the ground surface, the two or more of the plurality of contact elements being in the depressed position to complement a profile of the object; and
a number of contact elements of the wheel engaged with the object on the ground surface varies depending on the profile of the object.

18. The powertrain of claim 16, wherein each of the contact elements includes a tire arranged on an outer surface thereof.

19. The powertrain of claim 11, wherein each of the gear teeth of the flywheel is independently movable between a raised position and a depressed position and biased to the raised position, each of the gear teeth of the flywheel configured to the depressed position when engaged with at least one of the gear tooth elements of the gear assembly.

20. The powertrain of claim 19, wherein two or more of the gear teeth of the flywheel are displaceable from the raised position to the depressed position to engage at least one of the plurality of gear tooth elements of the gear assembly, the two or more of the gear teeth of the flywheel being in the depressed position to complement a profile of the at least one of the plurality of gear tooth elements of the gear assembly.

21. A method of operating a continuously variable transmission, the continuous variable transmission including:
a first circular gear having a rim portion, the first circular gear including a plurality of gear tooth elements arranged on the rim portion; and
a second circular gear including a gear plate, the gear plate having a plurality of gear teeth;
the first circular gear being arranged perpendicular to the second circular gear and configured to rotate about a first axis of rotation, and the plurality of gear teeth being arranged to extend radially outwardly from a second axis of rotation such that a width between adjacent gear teeth becomes larger as the gear teeth extend from the second axis of rotation;
the method comprising:
engaging at least one of the plurality of gear tooth elements of the first circular gear with at least one of the plurality of gear teeth of the second circular gear; and
moving the first circular gear radially relative to the second axis of rotation to change a position of the first circular gear on the gear plate of the second circular gear while the gear tooth elements of the first circular gear remain engaged with the gear teeth of the second circular gear.

22. The method of claim 21, wherein each of the gear tooth elements of the first circular gear is independently movable between a raised position and a depressed position and biased to the raised position, each of the gear tooth elements configured to move to the depressed position when engaged with at least one of the gear teeth of the second circular gear.

23. The method of claim 22, further comprising:
moving the first circular gear to a first position on the gear plate of the second circular gear; and
moving the first circular gear to a second position on the gear plate of the second circular gear, the second position defined as a position further from the second axis of rotation than the first position, wherein as the first circular gear moves from the first position to the second position, a number of the gear tooth elements of the first circular gear engaged with adjacent gear teeth of the second circular gear increases.
